(19) United States
(12) Patent Application Publication
(10) Pub. No.: US 2021/0279965 A1
(43) Pub. Date: Sep. 9, 2021

(54) METHOD, SYSTEM, COMPUTER PROGRAM PRODUCT AND COMPUTER-READABLE STORAGE MEDIUM FOR CREATING AN AUGMENTED REALITY ENVIRONMENT

(71) Applicant: National Taipei University of Technology, Taipei City (TW)

(72) Inventors: Leeh-Ter YAO, Taipei City (TW); Huei-Jyuan LIN, Taipei City (TW); Li-Yuan YEH, Taipei City (TW); Yu-Chieh TSAI, Taipei City (TW); Yu-Siao JHENG, Taipei City (TW)

(73) Assignee: National Taipei University of Technology, Taipei City (TW)

(21) Appl. No.: 16/912,447

(22) Filed: Jun. 25, 2020

(30) Foreign Application Priority Data
Mar. 5, 2020 (TW) 109107312

(51) Int. Cl. G06T 19/00; G06T 19/20

(52) U.S. Cl. CPC G06T 19/006; G06T 19/20

(57) ABSTRACT

A method of creating an augmented reality (AR) environment is implemented using an AR device and includes: controlling an image capturing unit to capture images of a movable electronic in a real environment; transmitting the action command to the movable electronic device to enable the movable electronic device to move; generating an AR image based on the images of the movable electronic device, the AR image including the movable electronic device located at a calculated location in the AR image, the calculated location being calculated based on a current location of the movable electronic device in the real environment; and displaying the AR image so as to present an AR environment.

### CROSS-REFERENCE TO RELATED APPLICATION

This application claims priority of Taiwanese Patent Application No. 109107312, filed on Mar. 5, 2020.

### FIELD

The disclosure relates to a method for creating an augmented reality (AR) environment.

### BACKGROUND

Conventionally, a number of movable electronic devices (e.g., a vehicle, a drone, etc.) maybe operated using a remote controller. There have been numerous applications that can make use of the configuration of using one or more remote controllers to control the movement of one or more movable electronic devices, such as an application of a car racing game.

### SUMMARY

One object of the disclosure is to provide a method of creating an augmented reality (AR) environment that is associated with a movable electronic device, for providing additional application for use of the movable electronic device.

According to one embodiment of the disclosure, the method of creating an augmented reality (AR) environment is implemented using an AR device included in an AR system. The AR device includes an image capturing unit, an input interface, a display screen, a communication unit and a processor coupled to the image capturing unit, the input interface, the display screen and the communication unit. The method includes:

controlling, by the processor, the image capturing unit to continuously capture real images of a movable electronic device that is located in a real environment and that is communicating with the AR device;

in response to receipt of a user-input action command associated with the movable electronic device via the input interface, controlling, by the processor, the communication unit to transmit the user-input action command to the movable electronic device, so as to make the movable electronic device move within the real environment according to the user-input action command;

generating, by the processor, at least one AR image based on the real images of the movable electronic device, the AR image including the movable electronic device, wherein the movable electronic device is located at a calculated location in the AR image, and the calculated location is calculated based on a current location of the movable electronic device in the real environment; and

controlling, by the processor, the display screen to display the AR image, so as to present an AR environment.

Another object of the disclosure is to provide an AR system that is capable of performing the above-mentioned method.

According to one embodiment of the disclosure, the AR system includes an AR device that includes an image capturing unit, an input interface, a display screen, a communication unit and a processor coupled to said image capturing unit, said input interface, said display screen and said communication unit. The processor is programmed to:

control the image capturing unit to continuously capture real images of a movable electronic device that is located in a real environment and that is communicating with the AR device;

in response to receipt of a user-input action command associated with the movable electronic device via the input interface, control the communication unit to transmit the user-input action command to the movable electronic device, so as to make the movable electronic device move within the real environment according to the user-input action command;

generate at least one AR image based on the real images of the movable electronic device, the AR image including the movable electronic device, wherein the movable electronic device is located at a calculated location in the AR image, and the calculated location is calculated based on a current location of the movable electronic device in the real environment; and

control the display screen to display the AR image, so as to present an AR environment.

Another object is to provide a computer program product comprising instructions that, when executed by a processor of an electronic device communicating with a movable electronic device, cause the processor to perform steps of the above-mentioned method.

Another object is to provide a non-transitory computer-readable storage medium storing instructions that, when executed by a processor of an electronic device communicating with a movable electronic device, cause the processor to perform steps of the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an augmented reality (AR) system and a movable electronic device according to one embodiment of the disclosure;

FIG. 2 is a schematic view illustrating the AR system and the movable electronic device which is located in a real environment according to one embodiment of the disclosure;

FIG. 3 is a flow chart illustrating steps of a method for creating an AR environment according to one embodiment of the disclosure; and

FIG. 4 is a flow chart illustrating sub-steps of a method for creating an AR environment according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” may refer to a direct connection among a plurality of electrical apparatus/devices/equipments via an electrically conductive material (e.g., an electrical wire), or an indirect connection between two electrical apparatus/devices/equipments via another one or more apparatus/device/equipment, or wireless communication.

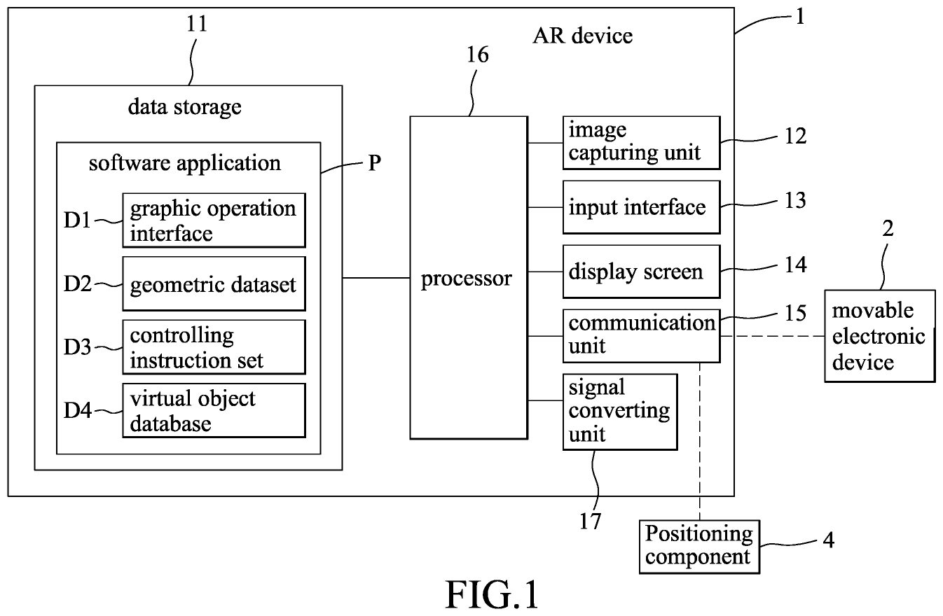

FIG. 1 is a block diagram illustrating an augmented reality (AR) system 100 and a movable electronic device 2 according to one embodiment of the disclosure.

The AR system 100 may include an AR device 1 that may be embodied using an electronic device such as a smartphone, a laptop, a personal computer, a tablet, or other general-purpose electronic devices.

In this embodiment, the AR device 1 is embodied using a smartphone, and includes a data storage 11, an image capturing unit 12, an input interface 13, a display screen 14, a communication unit 15 and a processor 16 coupled to the data storage 11, the image capturing unit 12, the input interface 13, the display screen 14 and the communication unit 15.

The data storage 11 maybe embodied using one or more of a hard disk, a solid-state drive (SSD) and other non-transitory storage medium.

The image capturing unit 12 may be embodied using a camera component built in the smartphone, or a camera that is external to and coupled to the smartphone.

The input interface 13 may be embodied using a physical keyboard, a virtual keyboard, a microphone, etc. In this embodiment, the input interface 13 and the display screen 14 are integrated in the form of a touchscreen. In the cases that the AR device 1 is embodied using a smartphone, the user may also input a command by speaking into the microphone built in the smartphone.

The communication unit 15 may include a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) and/or fourth generation (4G) of wireless mobile telecommunications technology, and/or the like.

The processor 16 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

In some embodiments, the AR device 1 may further include a signal converting unit 17 that is configured to convert a wireless signal (e.g., a Bluetooth®) signal into a radio-frequency (RF) signal, and to output the RF signal.

The movable electronic device 2 may be embodied using a remote-controllable mechanical device, and can be controlled to move within a real environment. It is noted that the movable electronic device 2 includes a communication component that is capable of communicating with the AR device 1 wirelessly (using, for example, a Bluetooth® or Wi-Fi communication) , and therefore may receive controlling signals from the AR device 1 so as to move according to the controlling signals.

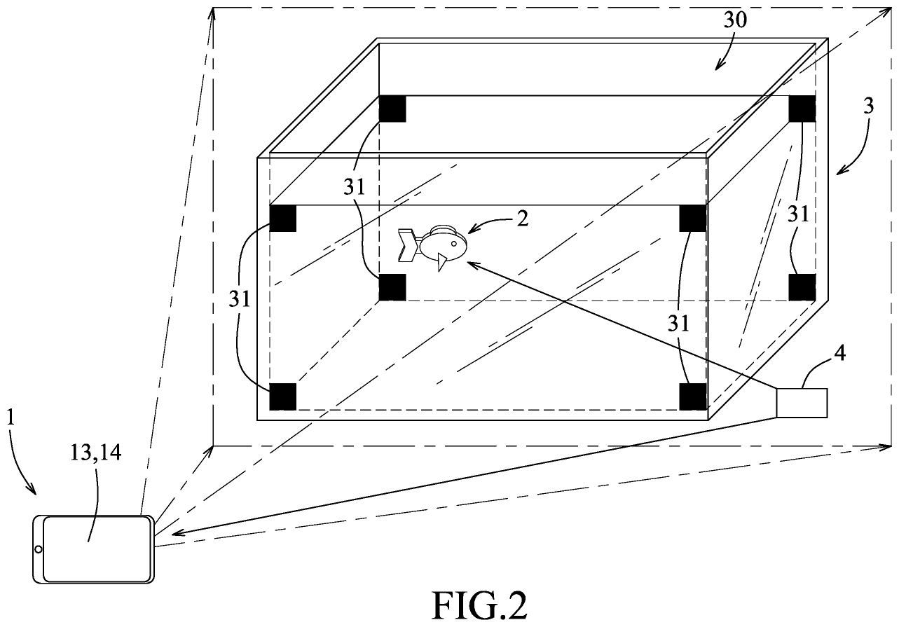

As shown in FIG. 2, in this embodiment, the movable electronic device 2 is a remote-controllable mechanical fish (robot fish) that can be disposed in a water container 3 containing water therein, with the water container 3 defining an inner space 30 that serves as the real environment. At least one surface of the water container 3 is transparent so as to enable the image capturing unit 12 of the AR device 1 to capture a real image of the movable electronic device 2 disposed in the water container 3.

It is noted that the detailed structure of the movable electronic device 2 and the mechanism in which the movable electronic device 2 moves within the water container 3 are well known in the related art, and details thereof are omitted herein for the sake of brevity.

In this embodiment, the water container 3 is provided with a plurality of reference points 31 that define a boundary of the inner space 30. The reference points 31 may be made using visible stickers that are put on the water container 3 at various positions (e.g., corners of the water container 3), respectively. In some examples, different numbers of the reference points 31 may be placed at other locations on the water container 3.

Referring back to FIG. 1, the data storage 11 stores a software application (P) that includes instructions that, when executed by the processor 16, cause the AR device 1 to perform operations as described below.

The software application (P) maybe downloaded from, for example, a server via a network (e.g., the Internet) by the communication unit 15, or loaded from a non-transitory computer-readable storage medium such as an externally connected flash memory or hard disk, a compact disc read-only memory (CD-ROM), etc.

Specifically, in this embodiment, the software application (P) is a gaming application, and contains instructions for providing a graphic operation interface (D1), a geometric dataset (D2) associated with the movable electronic device 2, a controlling instruction set (D3) for controlling movement of the movable electronic device 2 in the real environment (i.e., the inner space 30 defined by the water container 3 in this embodiment), and a virtual object database (D4).

The graphic operation interface (D1) may be in the form of a virtual joystick and a number of virtual buttons, and may be displayed on the display screen 14. The geometric dataset (D2) may be embodied using a three-dimensional (3D) model of the movable electronic device 2, a 3D point cloud set that defines the surface of the movable electronic device 2, or a number of two dimensional (2D) images of the movable electronic device 2, etc.

The geometric dataset (D2) is used for detecting the movable electronic device 2 from a real image taken by the image capturing unit 12, and for determining a posture of the movable electronic device 2 in the real environment. The term “posture” throughout the disclosure refers to a number of characteristics of the movable electronic device 2, including a location of the movable electronic device 2, a forward direction in which the movable electronic device 2 “faces”, etc.

The controlling instruction set (D3) may include a forward instruction for controlling the movable electronic device 2 to move in the forward direction in the water, a reverse instruction for controlling the movable electronic device 2 to move reversely in a direction opposite to the forward direction in the water, a left turn instruction for controlling the movable electronic device 2 to turn left in the water, a right turn instruction for controlling the movable electronic device 2 to turn right in the water, a diving instruction for controlling the movable electronic device 2 to dive down, a rising instruction for controlling the movable electronic device 2 to rise within the water, a clockwise rotating instruction for controlling the movable electronic device 2 to rotate clockwise, a counter-clockwise rotating instruction for controlling the movable electronic device 2 to rotate counter-clockwise, etc.

In use, a user of the AR device 1 may operate the input interface 13 to input a number of user input action commands, which are interpreted by the processor 16 as one or more corresponding instructions in the controlling instruction set (D3).

Then, the processor 16 controls the communication unit 15 to transmit the one or more corresponding instructions to the movable electronic device 2, so as to control the movable electronic device 2 to move accordingly. In some embodiments, the one or more corresponding instructions are converted into RF signals and outputted by the signal converting unit 17, so as to enable the movable electronic device 2, which may be submerged in the water, to receive the one or more corresponding instructions in the form of RF signals.

The virtual object database (D4) includes a plurality of visually distinct objects that can be accessed by the processor 16 for displaying on the display screen 14. In this embodiment, the virtual object database (D4) may include an equipment subset, a loot subset, a combat-related subset and an environment subset.

The equipment subset includes objects categorized as equipments that the movable electronic device 2 can be equipped with, such as a weapon, a defensive equipment, an accessory, etc. The loot subset includes, for example, treasure chests, in-game currencies, etc. The combat-related subset includes objects related to a combat such as monster sprites, projectiles, traps, etc. The environment subset includes objects that constitute an AR environment, such as backgrounds, effects in the environment, etc. It is noted that each of the objects included in the virtual object database (D4) may be in the form of a 2D or a 3D object.

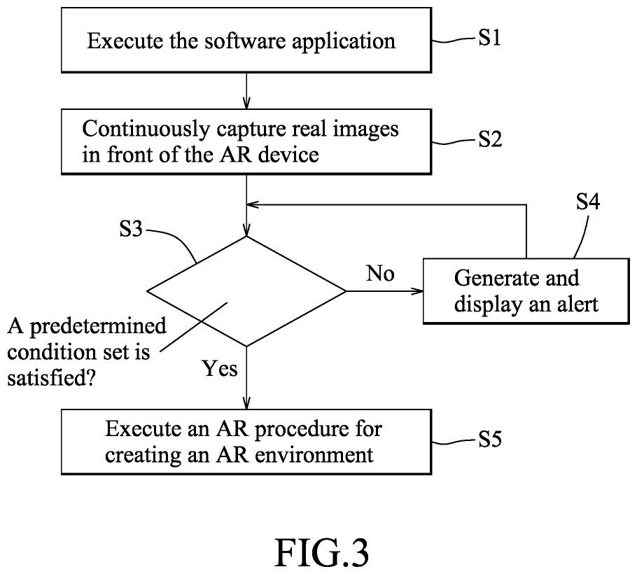

FIG. 3 is a flow chart illustrating steps of a method for creating an augmented reality (AR) environment according to one embodiment of the disclosure. In this embodiment, the method is implemented using the AR device 1 operating with the movable electronic device 2 as shown in FIGS. 1 and 2.

In use, a user of the AR device 1 may operate the input interface 13 to input a command (e.g., click on an icon for the software application (P) displayed on the touch screen 14) to execute the software application (P). In response, the processor 16 executes the software application (P) in step S1.

In executing the software application (P), the graphic operation interface (D1) may be invoked and displayed on the display screen 14.

In step S2, the processor 16 controls the image capturing unit 12 to continuously capture real images (in the form of a video or a plurality of images captured in rapid succession) in front of the AR device 1. In this embodiment, the controlling of the image capturing unit 12 is done in response to receipt of another user input command via the input interface 13 or the operation graphic interface (D1) (e.g., a click on a button displayed on the touch screen 14). In some embodiments, the controlling of the image capturing unit 12 is done automatically after step S1.

In step S3, the processor 12 determines, based on the real images taken in step S2, whether a predetermined condition set is satisfied. In this embodiment, the predetermined condition set includes that a boundary of the real environment is identified in the real images, and that the movable electronic device 2 is detected as being within the boundary of the real environment in the real images. Specifically, in this embodiment, when the reference points 31 disposed on the water container 3 are all detected in the real images, and when the movable electronic device 2 is detected as being within the boundary of the real environment in the real images, the processor 16 determines that the predetermined condition set is satisfied. When the determination of step S3 is affirmative, the flow proceeds to step S5. Otherwise (i.e., the predetermined condition set is not satisfied), the flow proceeds to step S4.

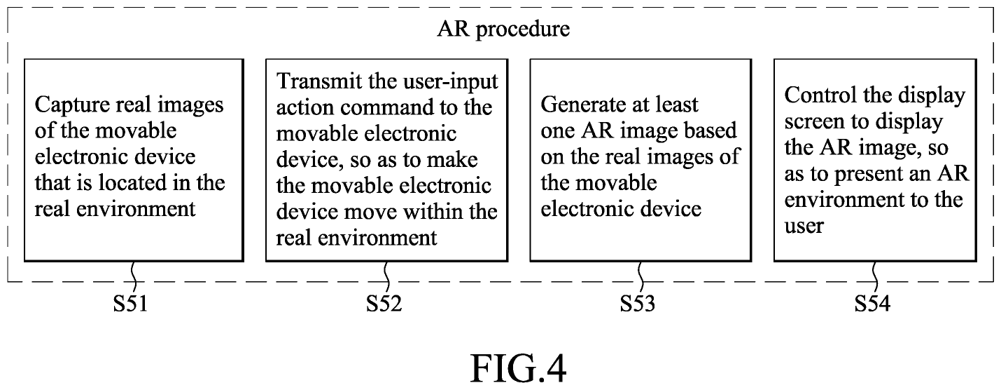

In step S4, the processor 16 generates an alert and controls the display screen 14 to display the alert. The alert may include text and/or images instructing the user to orientate the AR device 1 to make the image capturing unit 12 face the movable electronic device 2 or the reference points 31. Afterward, the flow may go back to step S3 when a predetermined time period (e.g., 10 seconds) has elapsed. In step S5, the processor 16 executes an AR procedure for creating an AR environment. In this embodiment, the AR procedure may be done by executing a number of sub-steps as seen in FIG. 4. It is noted that two or more of the sub-steps may be implemented simultaneously by the processor 16 in a multitasking manner, and are not necessarily performed in a sequential order.

In sub-step S51, the processor 16 controls the image capturing unit 12 to continuously capture real images of the movable electronic device 2 that is located in the real environment and that is communicating with the AR device 1. In this embodiment, the image capturing unit 12 is controlled to record a video of the movable electronic device 2.

In sub-step S52, in response to receipt of a user-input action command associated with operation of the movable electronic device 2 via the input interface 13, the processor 16 controls the communication unit 15 to transmit the user-input action command to the movable electronic device 2, so as to make the movable electronic device 2 move within the real environment according to the user-input action command.

Specifically, in this embodiment, the graphic operation interface (D1) may be displayed on the display screen 14, and may be operated by the user to generate the user-input action command. In response to receipt of the user-input action command, the processor 16 may obtain one or more instructions included in the controlling instruction set (D3) according to the user-input action command, and transmit the one or more instructions to the movable electronic device 2, so as to enable the movable electronic device 2 to move within the real environment. For example, when the user touches an up button of the graphic operation interface (D1), the processor 16 receives a user-input action command associated with rising movement of the movable electronic device 2, and accordingly, obtains the rising instruction from the controlling instruction set (D3) according to the user-input action command, and transmits the rising instruction to the movable electronic device 2, making the movable electronic device 2 rise.

In sub-step S53, the processor 16 generates at least one AR image based on the real images of the movable electronic device 2 taken in sub-step S51. The AR image includes the movable electronic device 2. The movable electronic device 2 is located at a calculated location in the AR image. The calculated location is calculated based on a current location of the movable electronic device 2 in the real environment. In some embodiments, the processor 16 generates a succession of AR images, with each AR image being generated based on a respective one of the real images of the movable electronic device 2.

Specifically, the calculated location may be calculated based on relationships each between the current location of the movable electronic device 2 and a corresponding one of the reference points 31. That is, the processor 16 may first calculate a real set of coordinates of the movable electronic device 2 in the inner space 30 based on displacements of the movable electronic device 2 individually with respect to the reference points 31 in at least two successive real images. Then, the processor 16 calculates a calculated set of coordinates of the movable electronic device 2 in the AR environment based on the real set of coordinates of the movable electronic device 2. It is noted that, for each of the reference points 31, a distance between the reference point 31 and any of other ones of the reference points 31 and a relative direction of the reference point 31 with respect to any of the other ones of the reference points 31 may be pre-stored in the data storage 11 or inputted by the user, and are used in calculating the real set of coordinates of the movable electronic device 2 in the inner space 30.

In this embodiment, the reference points 31 are utilized to define a boundary of the real environment (the inner space 30 of the water container 3 to be specific), and the displacements of the movable electronic device 2 with respect to the reference points 31 also indicate a real location of the movable electronic device 2 in the water container 3. As such, the real set of coordinates of the movable electronic device 2 acquired in this manner may be absolute regardless of the position of the image capturing unit 12 with respect to the movable electronic device 2; in other words, relative positional relationship between the image capturing unit 12 and the movable electronic device 2 has no influence on the determination of the real set of coordinates of the movable electronic device 2.

In sub-step S54, the processor 16 controls the display screen 14 to display the AR image, so as to present an AR environment to the user.

It is noted that, after the AR environment is presented, the user is enabled to interact with the AR environment by using the graphic operation interface (D1) to control the movable electronic device 2 to move within the real environment and/or to perform actions associated with the movable electronic device 2. In response, one or more of the sub-steps in the AR procedure maybe implemented to reflect the operations of the user.

In one example, based on the real images of the movable electronic device 2, the processor 16 may obtain the real location of the movable electronic device 2 in the water container 3 (for example, at an upper left portion of the water container 3) based on the real set of coordinates of the movable electronic device 2. Then, based on the real location of the movable electronic device 2 and the location of the image capturing unit 12 with respect to the water container 3, the generated AR image may include the movable electronic device 2 at an upper left portion of the AR image. In order to control the movable electronic device 2 to move to a lower right portion of the AR image, the user may operate the graphic operation interface (D1) (e.g., to operate the virtual joystick).

In response, as the movable electronic device 2 makes a movement in a direction that is associated with the user-input action command inputted by the user, the sub-steps S51 and S53 are simultaneously implemented. That is, the image capturing unit 12 continues recording the video, and based on the video, the processor 16 generates a succession of AR images to reflect the movement of the movable electronic device 2.

In this example, the succession of AR images may show the movable electronic device 2 “moving” toward the lower right portion of the AR images.

In some embodiments, in generating the AR images, the movable electronic device 2 may be included in the AR images as an AR object with a posture of the movable electronic device 2. In some embodiments, the AR object maybe in the form of an image of the movable electronic device 2 combined with at least one virtual object. In other embodiments, the movable electronic device 2 itself may be transformed into a virtual object in the AR images to serve as the AR object, or may be associated with other virtual objects to serve collectively as the AR object.

In one embodiment where the software application (P) is a gaming application, the AR object is utilized as a character sprite that is an image associated with a visual appearance of a player character, and that may be associated with at least one virtual object (e.g., equipment object stored in the virtual object database (D4) such as weapons, a helmet, an armor, etc., or effects indicating a status effect such as a buff, a de-buff, healing effect, poisoned effect, etc.).

In use, the equipment objects and the effect may be attached to part(s) of the character sprite (e.g., holding a weapon, wearing a helmet, etc.) or hover in the proximity of (above, below or surrounding) the character sprite.

It is noted that the virtual object is located at a relative location in each AR image, and the relative location is calculated based on the calculated location of the movable electronic device 2 in the AR image. That is to say, as the character sprite makes a movement, the associated equipment objects and effects are moved according to the movement. In some cases, the relative location may be calculated based on relationships between the current location of the movable electronic device 2 and the reference points 31.

In use, in response to determination of a movement of the movable electronic device 2, the processor 16 calculates a reactive movement associated with the virtual object.

Then, the processor 16 generates further AR images based on the real images of the movable electronic device 2 that are captured by the image capturing unit 12 during the movement of the movable electronic device 2 and based on the reactive movement that is associated with the virtual object. Afterward, the processor 16 controls the display screen 14 to display the further AR images thus generated. In use, as the movable electronic device 2 (the character sprite) makes a movement, the equipment(s) “worn” by the character sprite should be adjusted in the AR images to reflect a change in the posture thereof according to the movement. In some examples, other objects associated with the character sprite (e.g., a missile carried by the character sprite) should be adjusted in the AR images as well.

Additionally, the processor 16 may further determine a posture of the movable electronic device 2, and when the movable electronic device 2 is controlled to rotate or to perform other actions that result in a change in the posture, the AR object may be generated to further reflect such a change. In use, as the movable electronic device 2 (the character sprite) makes a rotation, the equipment(s) “worn” by the character sprite should be rotated in the AR images accordingly. In the case that the virtual object is in the form of a 3D object, the AR images may show a rotated view of the virtual object.

In some embodiments, based on the content of the game, the AR images generated in sub-step S53 may include an interactive virtual object that is located at a location different from that of the AR object. For example, the interactive virtual object may be an object that is independent from the character sprite and that can interact with the character sprite, such as a dropped item (gold, equipment, materials, etc.), a loot chest, a monster, an object included in the environment subset of the virtual object database (D4), etc.

In this embodiment, the relative location of the interactive virtual object is calculated based on the current location of the movable electronic device 2 in the real environment. In other embodiments, the relative location of the interactive virtual object may be a predetermined location associated with the real environment. That is to say, the relative location of the interactive virtual object may be calculated based on a boundary and/or a size of the real environment (the inner space 30 of the water container 3).

In use, after the interactive virtual object is displayed in an AR image, the user may operate the graphic operation interface (D1) or the input interface 13 to input an interaction command, so as to control the character sprite to “interact” with the interactive virtual object. In response, the processor 16 calculates an interaction between the AR object and interactive virtual object, generates further AR images based further on the interaction between the AR object and interactive virtual object, and controls the display screen 14 to display the further AR images thus generated.

For example, in the case that the interactive virtual object is a loot chest or a dropped item, the user may first control the character sprite to move toward the interactive virtual object, and, when the character sprite is in proximity of the interactive virtual object, to interact with the interactive virtual object (i.e., open the chest or pick up the item).

In the case that the interactive virtual object is an enemy or a monster, the user may control the character sprite to perform a ranged attack (e.g., shooting an arrow or throwing a fireball at the enemy, etc.) or to move toward the interactive virtual object, and, when the character sprite is in proximity of the interactive virtual object, to perform a closed range attack (e.g., swing a sword, throw a punch, etc.).

The attack may generate another virtual object that moves toward the interactive virtual object, and when coming into contact with the interactive virtual object, results in a contact interaction (e.g., damage dealt to the enemy).

In the case that the interactive virtual object is a trap, when the user controls the character sprite to move into contact with the trap, an interaction may be the trap getting activated, resulting in a contact interaction (e.g., damage dealt to the character sprite). Specifically, in response to determination of a movement of the movable electronic device 2, the processor 16 calculates an updated calculated location of the AR object in the AR images to reflect the movement. When it is determined, based on the updated calculated location and a location of the virtual object, that the AR object and the virtual object are in contact in an AR image, the processor 16 calculates a contact interaction between the virtual object and the AR object. Then, the processor 16 generates further AR images based on the contact interaction (e.g., the trap closing) , and controls the display screen 14 to display the further AR images.

According to one embodiment of the disclosure, the software application (P) is a role-playing game (RPG) gaming application, the player character indicated by the character sprite is a virtual pet (e.g., a pet fish) that is bound with the movable electronic device 2, and the game may be played in one of a number of modes. In this embodiment, the game may be played in one of a single player campaign, a player versus player (PvP) mode and an owner-pet interaction mode.

In the single player campaign, the user operates the graphic operation interface (D1) of the input interface 13 to control the action of the character sprite (the

AR object) within the real environment. In this embodiment, the AR object maybe in the form of an image of the movable electronic device 2 combined with at least one virtual object. In other embodiments, the movable electronic device 2 itself may be transformed into a virtual object in the AR images to serve as the AR object, or may be associated with other virtual objects to serve collectively as the AR object.

It is noted that the control of the action of the character sprite maybe done in the manner as described above, and details thereof are omitted herein for the sake of brevity.

When the user sees an interactive virtual object (e.g., a monster), he/she may control the character sprite to interact with the interactive virtual object (e.g., to attack). For example, the user may control the character sprite to first face the interactive virtual object by controlling the movable electronic device 2 (and thus, the character sprite) to rotate, and then control the character sprite to execute an attack (e.g., swing a weapon, fire a missile, etc.) when it is determined by the user that the character sprite is facing the interactive virtual object. In some examples, the attack may be executed automatically when it is determined that the interactive virtual object is within an attack range. For example, when it is determined that a distance between the character sprite and the interactive virtual object is shorter than the attack range associated with a melee weapon held by the character sprite, the character sprite may be controlled to automatically swing the weapon at the interactive virtual object. In another example, when it is determined that an angle formed by a line between the character sprite and the interactive virtual object and a line of a point of view (POV) of the character sprite is smaller than a predetermined angle, the character sprite may be controlled to automatically fire a missile at the interactive virtual object.

Based on the interaction between the character sprite and the interactive virtual object, other aspects of the RPG may be applied. For example, when the monster is defeated, one or more items maybe dropped (in the form of virtual objects) , experience points may be awarded to the player character, and attributes associated with the player character (e.g., level, offensive stats, defensive stats, etc.) may be increased.

In the PVP mode, two or more users, each using an AR device 1 to control a movable electronic device 2, may interact with one another. In one example, all the users and the corresponding movable electronic devices 2 controlled respectively by the users may be in the same real environment. In other examples, each of the users and the corresponding movable electronic device 2 maybe in a separate real environment, and a character sprite of one of the users maybe generated and projected on an AR image displayed by the AR device 1 of the other users as an interactive virtual object. In this mode, each character sprite may include additional virtual objects (e.g., a name of the player character).

In this mode, when the user sees an interactive virtual object (e.g., the character sprite of another player character), he/she may control the corresponding character sprite to interact with the interactive virtual object, (e.g., to attack). For example, the user may control the character sprite to first face the interactive virtual object (as described above), and then control the corresponding character sprite to execute an attack (e.g., swing a weapon, fire a missile, etc.).

It is noted that the attack may be executed automatically as described in the single player campaign. When one of the player characters is defeated, one or more items may be dropped (in the form of virtual objects) , experience points may be awarded to each of the other player characters, and attributes associated with each of the other player characters (e.g., level, offensive stats, defensive stats, etc.) may be increased.

In the owner-pet interaction mode, the user may operate the graphic operation interface (D1) or the input interface 13 to input an interaction command. In response to the receipt of the interaction command, the processor 16 may determine a reaction of the character sprite, and generate further AR images to reflect the reaction. It is noted that the reaction may be determined using artificial intelligence (AI) techniques to indicate an owner-pet relationship.

According to one embodiment of the disclosure, the AR device 1 is embodied using a computer device that is coupled to an external camera fixed in place (for example, using a tripod disposed in front of the real environment) to be able to continuously capture images of the real environment. The external camera may be embodied using a webcam, a sports cam, a depth camera, etc. In this configuration, the user is not required to manually keep the image capturing unit 12 to focus on the real environment, and the operations of steps S3 and S4 may be omitted.

According to one embodiment of the disclosure, the AR system 100 may further include a positioning component 4 disposed in the proximity of the real environment (i.e., the inner space 30 of the water container 3). The positioning component 4 is coupled to the AR device 1 and is configured to detect a location of the movable electronic device 2 in the real environment, using one of ultrasound wave, radio wave, sound navigation ranging (SONAR), InfraRed, Ultra-Wide band (UWB), etc.

In this configuration, in the sub-step S53 of generating the at least one AR image, the calculated location is calculated further based on a detected location detected by the positioning component 4. One effect of such a configuration is that, by employing the positioning component 4, the location of the movable electronic device 2 in the real environment can be calculated even if the image capturing unit 12 temporarily fails to capture the real images of the movable electronic device 2.

In various embodiments of the disclosure, the movable electronic device 2 may be embodied using a drone, a vehicle, or other devices that can be controlled remotely to move. Accordingly, the real environment may be defined as a section of air space, a section of floor, etc.

According to one embodiment of the disclosure, there is provided a computer program product that includes instructions that, when executed by a processor of an electronic device communicating with a movable electronic device, cause the processor to perform steps of a method as described in FIGS. 3 and 4.

According to one embodiment of the disclosure, there is provided a non-transitory computer-readable storage medium storing instructions that, when executed by a processor of an electronic device communicating with a movable electronic device, cause the processor to perform steps of a method as described in FIGS. 3 and 4.

To sum up, the embodiments of the disclosure provide an AR system 100 and a method for creating an AR environment. By operating the AR device 1 of the AR system 100 to control the movement of a movable electronic device 2, an AR environment created by the AR system 100 maybe utilized in a number of applications such as an RPG, thereby enabling the user to experience the RPG within the AR environment.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of creating an augmented reality (AR) environment, implemented using an AR device included in an AR system, the AR device including an image capturing unit, an input interface, a display screen, a communication unit and a processor coupled to the image capturing unit, the input interface, the display screen and the communication unit, the method comprising steps of:
controlling, by the processor, the image capturing unit to continuously capture real images of a movable electronic device that is located in a real environment and that is communicating with the AR device;
in response to receipt of a user-input action command associated with the movable electronic device via the input interface, controlling, by the processor, the communication unit to transmit the user-input action command to the movable electronic device, so as to make the movable electronic device move within the real environment according to the user-input action command;
generating, by the processor, at least one AR image based on the real images of the movable electronic device, the AR image including the movable electronic device, wherein the movable electronic device is located at a calculated location in the AR image, and the calculated location is calculated based on a current location of the movable electronic device in the real environment; and
controlling, by the processor, the display screen to display the AR image, so as to present an AR environment.

2. The method of claim 1, wherein the step of generating at least one AR image includes generating a virtual object located at a relative location in the AR image, the relative location being calculated based on the calculated location of the movable electronic device in the AR image.

3. The method of claim 2, further comprising:
in response to determination of a movement of the movable electronic device, calculating, by the processor, a reactive movement associated with the virtual object in the AR image;
generating, by the processor, another AR image based on the real images of the movable electronic device that are captured during the movement of the movable electronic device and the reactive movement associated with the virtual object; and
controlling, by the processor, the display screen to display the another AR image.

4. The method of claim 1, wherein the step of generating at least one AR image includes generating an interactive virtual object located at a relative location of the AR image, the relative location being calculated based on the current location of the movable electronic device in the real environment.

5. The method of claim 1, wherein the step of generating at least one AR image includes generating an interactive virtual object located at a relative location of the AR image, the relative location being calculated based on a boundary of the real environment.

6. The method of claim 1, wherein:
the step of generating at least one AR image includes generating an AR object associated with the movable electronic device, and an interactive virtual object located at a location in the AR image that is different from that of the AR object;
the method further comprising
in response to receipt of an interaction command from the input interface, calculating, by the processor, an interaction between the AR object and the interactive virtual object,
generating, by the processor, another AR image based on the interaction between the AR object and the interactive virtual object, and
controlling, by the processor, the display screen to display the another AR image.

7. The method of claim 1, wherein:
the step of generating at least one AR image includes generating an AR object;
the method further comprising
in response to determination of a movement of the movable electronic device, calculating, by the processor, an updated calculated location of the AR object in the AR image to reflect the movement,
when it is determined, based on the updated calculated location and a location of the virtual object, that the AR object and the virtual object are in contact in the AR image, calculating, by the processor, a contact interaction between the first virtual object and the AR object,
generating, by the processor, another AR image based on the contact interaction, and
controlling, by the processor, the display screen to display the another AR image.

8. The method of claim 1, wherein the real environment is an inner space of a water container that contains water therein.

9. The method of claim 8, the water container being defined with a plurality of reference points that define a boundary of the real environment,
wherein, in generating the AR image, the calculated location is calculated further based on relationships each between the current location of the movable electronic device and a corresponding one of the reference points.

10. The method of claim 1, wherein the step of generating at least one AR image includes:
determining, by the processor, a posture of the movable electronic device; and
generating the AR image further based on the posture of the movable electronic device.

11. The method of claim 1, the AR system further including a positioning component coupled to the AR device and configured to detect a location of the movable electronic device,
wherein, in generating the AR image, the calculated location is calculated further based on a detected location detected by the positioning component.

12. An augmented reality (AR) system for creating an AR environment, the AR system comprising an AR device that includes an image capturing unit, an input interface, a display screen, a communication unit and a processor coupled to said image capturing unit, said input interface, said display screen and said communication unit, said processor being programmed to:
control said image capturing unit to continuously capture real images of a movable electronic device that is located in a real environment and that is communicating with said AR device;
in response to receipt of a user-input action command associated with the movable electronic device via said input interface, control said communication unit to transmit the user-input action command to the movable electronic device, so as to make the movable electronic device move within the real environment according to the user-input action command;
generate at least one AR image based on the real images of the movable electronic device, the AR image including the movable electronic device, wherein the movable electronic device is located at a calculated location in the AR image, and the calculated location is calculated based on a current location of the movable electronic device in the real environment; and
control said display screen to display the AR image, so as to present an AR environment.

13. The AR system of claim 12, wherein:
said processor is programmed to generate the at least one AR image by generating a virtual object located at a relative location in the AR image, wherein the relative location is calculated by said processor based on the calculated location of the movable electronic device in the AR image.

14. The AR system of claim 12, wherein said processor is programmed to generate the at least one AR image by generating an interactive virtual object located at a relative location in the AR image, the relative location being calculated based on the current location of the movable electronic device in the real environment.

15. The AR system of claim 12, wherein said processor is programmed to generate the at least one AR image by generating an interactive virtual object located at a relative location in the AR image, the relative location being calculated based on a boundary of the real environment.

16. The AR system of claim 12, wherein:
said processor is programmed to generate the at least one AR image by generating an AR object associated with the movable electronic device, and an interactive virtual object located at a location different from that of the AR object;
wherein said processor is further programmed to
in response to receipt of an interaction command from said input interface, calculate an interaction between the AR object and interactive virtual object,
generate another AR image based on the interaction between the AR object and interactive virtual object, and
control said display screen to display the another AR image.

17. The AR system of claim 12, wherein:
said processor is programmed to generate the at least one AR image by generating an AR object;
wherein said processor is further programmed to
in response to determination of a movement of the movable electronic device, calculate an updated calculated location of the AR object in the AR image to reflect the movement,
when it is determined, based on the updated calculated location and a location of the virtual object, that the AR object and the virtual object are in contact in the AR image, calculate a contact interaction between the virtual object and the AR object,
generate another AR image based on the contact interaction, and
control said display screen to display the another AR image.

18. The AR system of claim 12, wherein the real environment is an inner space of a water container that contains water therein.

19. The AR system of claim 12, wherein said processor is programmed to generate the at least one AR image by:
determining a posture of the movable electronic device; and
generating the AR image further based on the posture of the movable electronic device.

20. The AR system of claim 12, further comprising a positioning component coupled to said AR device and configured to detect a location of the movable electronic device,
Wherein, in generating the AR image, said processor calculates the calculated location further based on a detected location detected by said positioning component.
